(19) United States
(12) Patent Application Publication
(10) Pub. No.: US 2005/0100746 A1
(43) Pub. Date: May 12, 2005

(54) Optical coatings and methods

(76) Inventor: Eric Krisl, Santa Rosa, CA (US)

Correspondence Address: DUANE MORRIS LLP, Suite 700, 1667 K Street, N.W., Washington, DC, 20006, US

(21) Appl. No.: 10/981,682

(22) Filed: Nov. 5, 2004

Related U.S. Application Data
(60) Provisional application No. 60/517,108, filed on Nov. 5, 2003.

(51) Int. Cl. B32B 9/04

(52) U.S. Cl. 428/446; 428/448; 428/689; 428/701; 427/162

(57) ABSTRACT

An optical coating formed by alternating high index and low index layers having one or more thin crystal growth inhibiting layers for inhibiting crystal growth in the high index material or the low index material. The crystal growth inhibiting layers are formed from a material different than the material in the adjacent layers of the coating. The material may be the same as or different from the high index material or low index material. According to one aspect of the invention, the ratio of the indices of refraction of the high index material to the low index material may be increased by the use of materials such as rutile titanium dioxide as the high index material while reducing the scatter by limiting the size of crystals in the material.

### CLAIM OF PRIORITY

This application claims the priority of U.S. Provisional Patent Application No. 60/517,108 filed Nov. 5, 2003, the content of which is incorporated herein by reference.

### BACKGROUND OF THE INVENTION

Multilayer optical coatings are typically formed by alternating layers of high index material and low index material. In such a multilayer optical coating, it is generally advantageous to form the coating from materials wherein the ratio of the indices of refraction of the high and low index materials is as large as possible. The number of layers required to achieve a desired optical performance is inversely proportional to the ratio. Additionally, superior optical performance can be achieved from a coating having an equal, or fewer, number of layers of materials having a higher ratio than from a coating having a lower ratio. The economics of a process for forming multilayer optical coatings is determined by the number of layers required to provide a desired optical performance, the rate at which such layers can be controllably deposited, and the surface area over which those deposition rates can be achieved.

Metal oxides have found wide use as the high index material and low index material in optical coatings due to the durability and transmission in the visual spectrum of such materials. Titanium dioxide (TiO2) has long been recognized as a potentially valuable high index material for optical coating applications because it is durable, visually transparent, and has a higher index that other suitable metal oxides. However, the use of titanium dioxide has been limited in manufacturing due to several difficulties in forming coatings. For example, titanium dioxide has three naturally occurring crystalline phases, the rutile, anatase, and brookite phases. Moreover, titanium dioxide may also be deposited in non-crystalline, amorphous form under certain conditions. Of the three phases, the rutile phase has the highest refractive index. Rutile titanium dioxide is birefringent, with an average index of 2.75 at 550 nm.

The rutile phase is also the most thermodynamically stable phase. One disadvantage of forming coatings using rutile phase titanium dioxide is the susceptibility of forming large crystals in the rutile phase material, particularly when the film is subjected to high temperatures. The large crystals are undesirable for most optical applications in view of the undesirable scattering and non-specularity caused by the crystals. The large crystal size also causes the films to have a rough surface morphology which is also undesirable. Finally, stress in the film is caused by growth of the rutile crystals which can cause cracks and other damage in the coating. The susceptibility of rutile titanium dioxide to grow large crystals at high temperatures has limited the use of this material despite the desirable high index of the material.

Other desirable high index materials such as tantalum oxide and niobium oxide are also susceptible to crystal growth when the material is subjected to high temperatures. These crystals are undesirable and can cause film scatter and even film failure in extreme cases.

For some important applications, for example coatings on the envelope of a high power lamp burner, such crystallization in the high index layers of the coating prevents the use of very desirable high index materials that would reduce the cost and improve the performance of the coatings. The high temperature crystallization of high index materials such as titanium dioxide and niobium pentoxide forces the use of lower index materials such as zirconium oxide as the high index material in high temperature optical coating applications. Because the zirconium oxide has a substantially lower refractive index, more layers are required to achieve the same optical performance in the coating which leads to higher costs.

One known method for reducing scatter in crystalline high index films is to anneal the anneal the coating to effect the formation of crystals that are relatively small compared to the wavelengths of light at which the optical coating is intended to operate. For example, multilayers of tantalum oxide and silicon dioxide deposited on a lamp envelope as a hot mirror subjected to a controlled anneal up to 800° C. with a dwell at 650° C. to allow small crystals of the tantalum oxide to grow. The resulting film stress is relieved in a manner that does not destroy the coating. If such a deposited film was not first annealed, the rapid rise in temperature of the coating resulting from lamp ignition would cause uncontrolled crystallization of the tantalum oxide, with undesirable scatter in the near infrared. The film may also structurally fail due to the internal stress caused by the crystal growth.

It is also known to dope the high index materials to inhibit the formation of crystals. This approach has met with limited success. Another prior art solution is to use lower index materials such as zirconium dioxide that do not form large crystals at the intended operating temperatures as the high index material. This solution is a compromise in that the lower index of the zirconia results in either lesser optical performance, or higher costs to obtain the same optical performance.

There remains a need for low scatter optical coatings for use in high temperature applications. The many objects and of the present invention will be readily apparent to one skilled in the art to which the invention pertains from a perusal of the claims, the appended drawings, and the following detailed description of the preferred embodiments.

### BRIEF DESCRIPTION OF THE DRAWINGS

FIGS. 1a and 1b are illustrations of a prior art multilayer coating.

FIG. 1c is an illustration of a coating having a crystal growth inhibiting layer according to one aspect of the present invention.

FIG. 2 is an illustration showing the theoretical spectral characteristics of coatings according to one aspect of the present invention.

FIG. 3 is an illustration of a system for measuring the scatter in a multilayer optical coating.

### DESCRIPTION

The present invention is directed generally to novel optical coatings and methods of making optical coatings. In one aspect, the present invention is directed to a multilayer optical coating having alternating high index layers and low index layers. The high index layers comprise a high index material and one or more thin layers of another material to inhibit crystal growth in the high index material. The crystal growth inhibiting layers are formed from a material that inhibits the propagation of crystals in the high index material at the operating temperatures of the coating. The thin crystal growth inhibiting layers are positioned so that there is no discrete layer of the high index material in the optical coating that is thicker than the largest acceptable crystal size in the high index material.

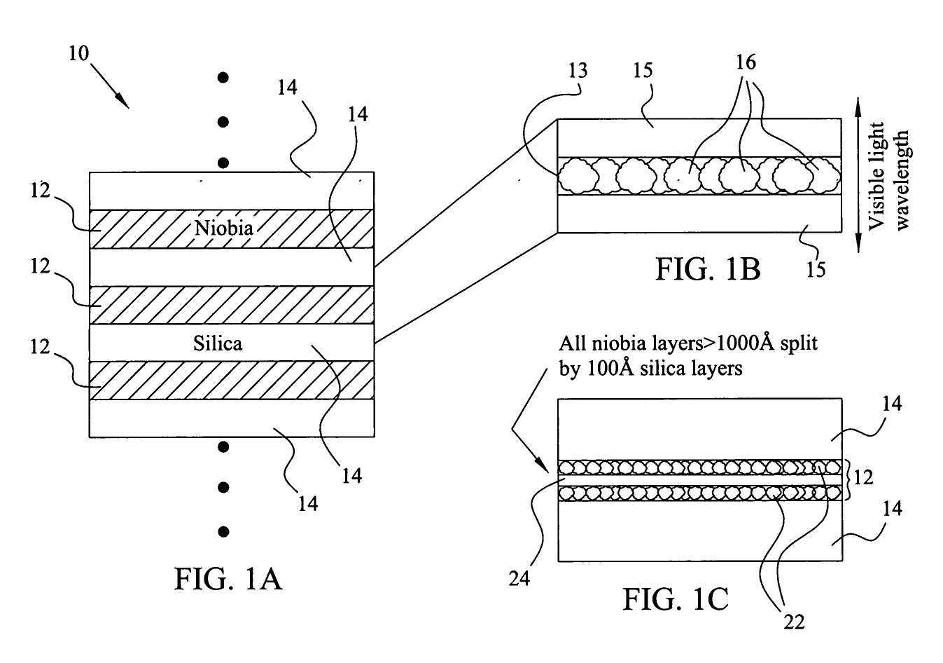

FIGS. 1a and 1b illustrate a portion of a typical optical coating. With reference to FIG. 1a, the coating portion 10 includes alternating high index layers 12 and low index layers 14. The high index layers 12 comprise any suitable high index material such as titanium dioxide, zirconium dioxide, or niobia. The low index layers comprise any suitable low index material such as silica.

A significant disadvantage of prior art optical coatings is the crystal growth in the high index material. With reference to FIG. 1b, growth of the crystals 16 in the high index layer 12 will not be inhibited until the crystal propagates to the boundaries between the high index material 13 and the low index material 15 at which point further propagation will be prevented due to the different structure of the low index material.

FIG. 1c illustrates a coating according to one aspect of the present invention. The high index layer 12 comprises layers 22 formed from high index material and a thin crystal growth inhibiting layer 24 formed intermediate the layers 22. The crystal growth inhibiting layer may be formed from a material that is either non-crystalline, or has a crystal structure sufficiently different from the high index material so that crystal growth in the high index layer cannot propagate through the material. The crystal growth inhibiting layer 24 is positioned so that the thickness of the adjacent layers 22 of high index material do not exceed a predetermined thickness. For example, the maximum thickness of any layer of high index material may be determined by the maximum acceptable size of crystals in the layer.

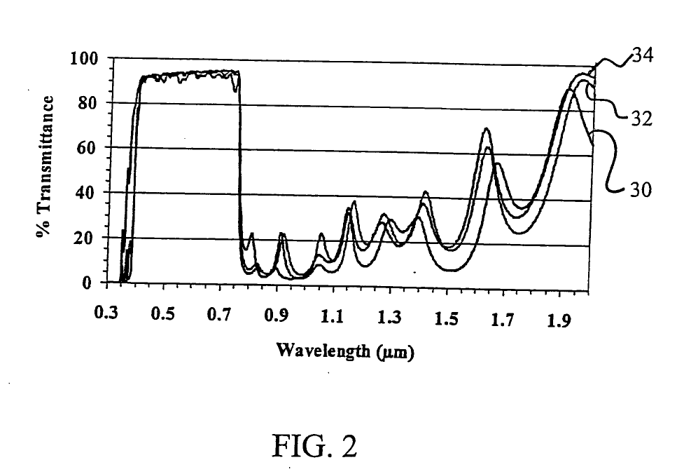

The reduction in the size of crystals in the high index material results in improved coating qualities such as a reduction in scatter. Moreover, because the crystal growth inhibiting layers are thin relative to the adjacent layers, the crystal growth inhibiting layers have little or no optical effect on the performance of the optical coating. For example, FIG. 2 illustrates the theoretical spectral characteristics (transmittance vs. wavelength) of a 47 layer coating of alternating high index layers and low index layers compared to the theoretical spectral characteristics of 47 layer coatings of alternating high index layers and low index layers having a plurality of thin crystal growth inhibiting layers formed in one or more of the high index layers. The curve 30 illustrates the characteristics of the original coating having 47 layers of high index and low index material. The curve 32 illustrates the characteristics of a coating having six crystal growth inhibiting layers (i.e., 53 total layers) comprising 100 angstrom layers of silica positioned so that the thickness of any layer of high index material does not exceed 1000 angstroms. The curve 34 illustrates the characteristics of a coating having twenty-four crystal growth inhibiting layers (i.e., 71 total layers) comprising 50 angstrom layers of silica positioned so that the thickness of any layer of high index material does not exceed 800 angstroms. As illustrated by FIG. 2, the optical effect of the thin crystal growth inhibiting layers on the spectral performance of the coating is minimal.

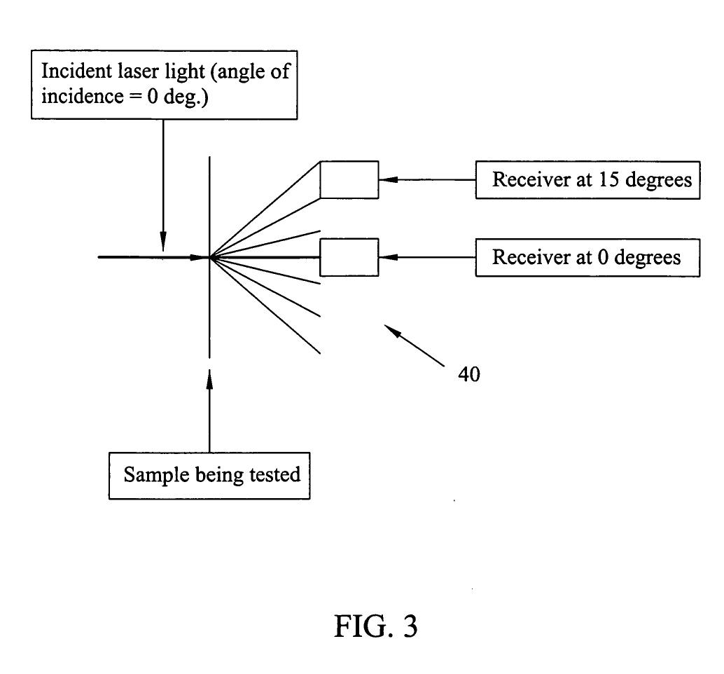

FIG. 3 illustrates a system for measuring the scatter produced by an optical coating. With reference to FIG. 3, the system 40 is a TMA Scatterometer operated in a transmission mode with the irradiance of the sample being measured at 0 degrees and 15 degrees. The scatter value is the log of the ratio of the irradiance at 0 degrees to the irradiance at 15 degrees.
TMA=Log(I at 0 degrees/I at 15 degrees)

For a sample with little or no scatter, very little light reaches the 15 degree receiver and the TMA value is high. For samples with a high amount of scatter, a greater degree of light reaches the 15 degree receiver and the TMA value is low. For the coatings modeled in determining the spectral characteristics illustrated in FIG. 2, the scatter was measured after sequential airbakes at 500° C. and 800° C. The table below illustrates that the designs with thin silica layers interposed to inhibit crystal growth had higher TMA scatter numbers, confirming that the thin crystal growth inhibiting layers reduce scatter in optical coatings.

| Bake | Coating 1 | Coating 2 | Coating 3 |
|---|---|---|---|
| None | 5.9 | 5.9 | 5.9 |
| 500° C. (1 hour) | 7.0 | 4.0 | 4.0 |
| 800° C. (1 hour) | 5.8 | 5.8 | 5.8 |
| 800° C. (4 hours) | 6.0 | 9.0 | 3.0 |
| 800° C. (24 hours) | 5.3 | 5.4 | 5.5 |

Coating 1 = 47 layer coating of alternating high index (niobia) and low index (silica) layers.
Coating 2 = Coating 1 plus 6 layers of silica (100 Å) positioned so that the thickness of any niobia layer does not exceed 1000 Å.
Coating 3 = Coating 1 plus 24 layers of silica (50 Å) positioned so that the thickness of any niobia layer does not exceed 800 Å.

### EXAMPLE

A multilayer coating of tantalum oxide and silicon dioxide having a periodic structure, where each period consists of a layer of tantalum oxide of 500 nm physical thickness and a layer of silicon dioxide of 650 nm physical thickness, with an intended operating temperature of 900° C. and a maximum allowable crystal size in the tantala layers of 100 nm. If the coating is formed without any thin crystal inhibiting layers, the maximum crystal size in the tantala layers will be 500 nm, i.e., the thickness of the layer.

According to one example of the present invention, the tantala layer of each period is replaced by the following structure:
100 nm Ta2O5
Material X
100 nm Ta2O5
Material X
100 nm Ta2O5
Material X
100 nm Ta2O5
Material X
100 nm Ta2O5

The Material X in the coating is a relatively thin layer of a material different from tantala. The Material X may be chosen from materials that are either non-crystalline or that have a crystal structure sufficiently different from the tantala that crystal growth in the tantala cannot propagate through the Material X. Therefore the maximum crystal size that can form in the tantala is 100 nm, i.e., the thickness of the tantala layers.

In forming optical coatings according to one aspect of the present invention, it is generally desirable to select a material to form the thin crystal growth inhibiting layers that has an index as high as possible, consistent with other material requirements for the thin layer. Having a relatively high index will minimize any effects of the thin crystal growth inhibiting layers on the optical performance of the coating.

For practical manufacturing reasons it may be desirable to form the thin crystal growth inhibiting layers in the high index layers from the same material as the low index material, e.g., silicon dioxide. Because of the relative thickness of the thin crystal growth inhibiting layers compared to the adjacent layers of high index material and the overall thickness of the high index layer, even the use of silicon dioxide will not have much effect on the optical performance of the coating.

The relative thicknesses of the crystal growth inhibiting layer to an adjacent layer will vary according to the particular design of the coating. In some designs, the thickness of the crystal growth inhibiting layer may be no greater than one tenth of the thickness of an adjacent layer, while in other designs the it may be no greater than one twentieth or smaller.

In another aspect of the present invention, the crystal growth inhibiting layers may be formed in the low index layers of the coating, or in both the low index and high index layers. In either aspect, the crystal growth inhibiting layers may be formed from the material in the coating other than the material forming the adjacent layers.

While preferred embodiments of the present invention have been described, it is to be understood that the embodiments described are illustrative only and that the scope of the invention is to be defined solely by the appended claims when accorded a full range of equivalence, many variations and modifications naturally occurring to those of skill in the art from a perusal hereof.

1. A high temperature multilayer optical coating with a low scatter high index layer comprising a plurality of high index layers and a plurality of low index layers, at least one of said high index layers comprising two layers of high index material and a layer of a second material intermediate said layers of high index material.

2. The optical coating of claim 1 wherein said low index layers comprise a low index material and second material is the same material as the low index material.

3. The optical coating of claim 2 wherein the thickness of said layer of second material is no more than one tenth the thickness of an adjacent layer of high index material.

4. The optical coating of claim 3 wherein the thickness of said layer of second material is no more than one twentieth the thickness of an adjacent layer of high index material.

5. In an optical coating comprising alternating high index layers and low index layers, the improvement comprising one or more layers of crystal growth inhibiting material in one or more of said high index or low index layers.

6. The optical coating of claim 5 wherein the one or more crystal growth inhibiting layers are spaced within a high index or low index layer so that the thickness of any discreet layer of high or low index material is no greater than a predetermined thickness.

7. The optical coating of claim 5 wherein one or more of the high index layers comprises a high index material and one or more crystal growth inhibiting layers formed from a material different from the high index material.

8. The optical coating of claim 7 wherein the low index layers comprise a low index material and one or more of the crystal growth inhibiting layers in the high index layer are formed from the low index material.

9. The optical coating of claim 5 wherein one or more of the low index layers comprises a low index material and one or more crystal growth inhibiting layers formed from a material different from the low index material.

10. The optical coating of claim 9 wherein the high index layers comprise a high index material and the crystal growth inhibiting layers in the low index layer are formed from the high index material.

11. An optical coating for operation at predetermined temperatures, said coating comprising alternating high index layers and low index layers, one or more of said high index layers comprising a high index material and one or more thin layers of a second material, said second material being selected so that crystal growth in said high index material does not propagate through said second material at said predetermined temperatures.

12. The optical coating of claim 11 wherein the low index layers comprise a low index material and the second material comprises the low index material.

13. An optical coating comprising alternating layers of materials having a high index of refraction and a low index of refraction wherein the thickness of one or more of the layers of material are no more than one tenth the thickness of the adjacent layers of material.

14. The optical coating of claim 13 wherein the thickness of one or more layers of low index material are no more than one tenth the thickness of an adjacent layer of high index material.

15. An optical coating comprising a plurality of layers of materials having different indices of refraction, one or more layers of material having a thickness that is no more than one tenth the thickness of the adjacent layers of material.

16. The optical coating of claim 15 wherein one or more layers of material having the lowest index of refraction have a thickness that is no more than one tenth the thickness of the adjacent layers of material.

17. The optical coating of claim 16 wherein the adjacent layers comprise the material having the highest index of refraction.

18. The optical coating of claim 15 wherein one or more of the layers of material having the lowest index of refraction have a thickness that is no more than one tenth the thickness of another layer of the same material.

19. The optical coating of claim 15 comprising a high index material, a low index material, and a third material, wherein the thickness of one or more layers of the third material is no more than one tenth the thickness of one or more layers of the high index material.

20. The optical coating of claim 19 wherein said one or more layers of third material are adjacent layers of high index material.

21. The optical coating of claim 15 comprising a high index material, a low index material, and a third material, wherein the thickness of one or more layers of the third material is no more than one tenth the thickness of one or more layers of the low index material.

22. An optical coating comprising alternating high index layers and low index layers, one or more of said high index layers comprising at least two layers of rutile titanium dioxide and one or more layers of silicon dioxide, said low index layers comprising silicon dioxide.

23. A method of making an optical coating having low scatter high index layers comprising the steps of:
forming a low index layer by depositing a layer of low index material; and
forming a high index layer by (i) depositing a layer of high index material, (ii) depositing a layer of a material different from the high index material, and (iii) depositing a layer of high index material.

24. The method of claim 23 wherein the material different from the high index material is the low index material.

25. A method of making an optical coating having low scatter low index layers comprising the steps of:
forming a high index layer by depositing a layer of high index material; and
forming a low index layer by (i) depositing a layer of low index material, (ii) depositing a layer of a material different from the low index material, and (iii) depositing a layer of low index material.

26. The method of claim 25 wherein the material different from the low index material is the high index material.

27. A method of making an optical coating comprising the steps of:
(a) selecting a low index material;
(b) selecting a high index material;
(c) determining the number and thickness of the layers of high and low index material;
(d) determining the maximum thickness of any discreet layer of high index material based on a maximum acceptable crystal size in the material;
(e) determining the number and position of layers of crystal growth inhibiting material to be formed so that the thickness of any discreet layer of high index material does not exceed the maximum thickness; and
(e) forming the layers of high index material, low index material, and crystal growth inhibiting material.

28. The method of claim 27 wherein the low index material and the crystal growth inhibiting material are the same material.

29. In an optical coating formed by alternating high index and low index layers, a method of reducing the scatter of the film comprising the step of forming one or more crystal growth inhibiting layers in one or more of the high index layers so that the thickness of any discreet layer of high index material does not exceed a predetermined thickness.

30. In an optical coating formed by alternating high index and low index layers, a method of reducing the scatter of the film comprising the step of forming one or more crystal growth inhibiting layers in one or more of the low index layers so that the thickness of any discreet layer of low index material does not exceed a predetermined thickness.
